(19) United States
(12) Patent Application Publication
(10) Pub. No.: US 2005/0184778 A1
(43) Pub. Date: Aug. 25, 2005

(54) Apparatus and method for increasing the performance of a clock-based digital pulse width modulation generator

(76) Inventor: David A. Figoli, Missouri City, TX (US)

Correspondence Address: TEXAS INSTRUMENTS INCORPORATED, P O BOX 655474, M/S 3999, DALLAS, TX, 75265, US

(21) Appl. No.: 10/909,886

(22) Filed: Aug. 2, 2004

Related U.S. Application Data
(60) Provisional application No. 60/547,549, filed on Feb. 25, 2004.

(51) Int. Cl. H02M 3/335

(52) U.S. Cl. 327/172

(57) ABSTRACT

To improve the performance of a pulse width modulator, a delay line having number of delay elements receives a pulse signal from the final clock cycle prior to the generation of the trailing edge of the pulse width modulator signal. Each delay element delays the pulse signal a fraction of the system clock cycle. By controlling the number of delay elements prior to the application of the pulse to the trailing edge-generating component, the trailing edge can be adjusted by increments of the clock cycle determined by the number of delay elements. Because parameters of delay elements can vary, a technique for the calibration of the delay line circuit is disclosed.

This application claims priority under 35 USC §119(e) (1) of Provisional Application No. 60/547,549 (TI-36499PS) filed Feb. 25, 2004.

### BACKGROUND OF THE INVENTION

1. Field of the Invention

This invention relates generally to digital circuits and, more particularly, to digital pulse width modulation circuits.

2. Background of the Invention

The digital pulse width modulator has number of uses in modern digital signal processing, one of the more important being power conversion regulation. The pulse width modulator controls the average power delivered to a destination by controlling a ratio of the time a positive signal is generated during a pulse period to the total period of the pulse.

Referring to FIG. 1, a block diagram of a pulse width modulator 10 according to the prior art is shown. Period register 101 and compare register 104 store a static value. Counter 103 has the system clock applied thereto. The output counter for counter 103 is applied to a first terminal of digital comparator 102 and to a first terminal of comparator 105. The value in the period register 101 is applied to a second terminal of comparator 102, while the value in the compare register 104 is applied to the second input terminal of comparator 105. The output terminal of the comparator 102 is applied to a clear terminal of DQ flip-flop 106 and to the reset terminal of counter 103. The output terminal of comparator 105 is applied to the set terminal of DQ flip-flop 106.

The operation of the pulse width modulator of FIG. 1 can be understood as follows. After a reset of the counter 103, the counter 103 increments on the system clock signal until the number in compare register 104 is reached. At this point, the output signal of the pulse width signal is generated at the Q terminal of the DQ flip-flop 106. The output signal at the Q terminal remains until the count in counter 103 is equal to the value in the period register 101. At this point, the output signal from comparator 102 causes the counter 103 to be reset and causes the output signal on the Q terminal to be cleared. The time during which the signal is applied to the Q terminal to the total time determined by the value in the period register is the duty cycle.

Referring to FIG. 2, the operation of the pulse width modulator shown in FIG. 1 is illustrated. When the count in counter reaches the value stored in period register 101, a logic “1” signal from the comparator 102 is applied to clear terminal of the DQ flip-flop 106 and to the reset terminal of counter 103. The signal applied to the clear terminal of the DQ flip-flop results in a logic “0” signal being applied to the Q terminal of the DQ flip-flop. The resetting of the counter 103 results in a logic “0” signal being applied to the first terminals of comparator 102 and comparator 103. As a result of these signals, the signals on the output terminals of comparator 102 and comparator 105 have logic “0” applied thereto. The logic “0” applied to the Q terminal of the DQ flip-flop 106 will be maintained until the value in the compare register 104 equals the current count from the counter 103, the count in counter 103 being incremented every clock cycle. When the count from counter 103 equals the value in the compare register 104, a logic “1” will be applied by comparator 105 to the set terminal of Q flip-flop 106, resulting in a logic “1” signal being applied to the Q terminal of DQ flip-flop 106. The logic “1” signal will be maintained at the Q terminal until the count from counter 103 is equal to the value in the period register 101. The process is then repeated.

Referring to FIG. 3, the output signal of the Q terminal is shown by the dark line. The ratio of the on-time to the period is the duty cycle of the pulse width modulator.

FIG. 3 also illustrates the problem with the prior art pulse width modulators. The ability to control the duty cycle depends in the apparatus shown in FIG. 1 on the clock signal width. When this width is too large, the pulse width modulator will have regulation problems, such as “hunting”, in order to acquire the “correct” duty cycle. One solution is to increase the rate of the system clock. However, the system clock can only be increased so much before the deterioration in the wave form and other parameters begin to compromise the signal integrity.

A need has therefore been felt for apparatus and an associated method for improving the performance of a pulse width modulator. It would be another feature of the apparatus and associated method to provide a control signal with several transitions during each system clock cycle. It would be a still further feature of the apparatus and associated method to provide pulse width modulator with a basic system clock and to provide apparatus providing controllable signal transitions following the last system clock cycle. It is a more particular object of the apparatus and associated method to provide increased granularity in a control signal controlling the duty cycle maintaining a constant period signal. It would be yet another feature of the apparatus and associated method to provide improved performance in a pulse width modulator by employing a delay line. It would be a more particular feature of the apparatus and associate method to permit the pulse width modulator to compensate for changes in the parameters of the delay line.

### SUMMARY OF THE INVENTION

The aforementioned and other features are accomplished, according to the present invention, by incorporating a delay line having predetermined number of delay elements coupled series in circuit carrying the transition control signal. The signal generated at the output terminal of a determined number of delay elements can be selected to provide the transition signal. In this manner, the leading edge of the pulse width modulator output signal can be extended a fractional amount of a system clock cycle by the number of selected delay elements. Because delay elements have known stability problems, a circuit is provided to compensate for lack of stability of the delay element.

Other features and advantages of present invention will be more clearly understood upon reading of the following description and the accompanying drawings and the claims.

### BRIEF DESCRIPTION OF THE DRAWINGS

FIG. 1 is a block diagram of a pulse width modulator according to the prior art.

FIG. 2 illustrates the waveforms arising from the pulse width modulator shown in FIG. 1.

FIG. 3 illustrates the output waveform of the pulse width modulator and the problem with the prior art circuit.

FIG. 4 is a block diagram of a pulse width modulator according to the present invention.

FIG. 5 is a block diagram of a delay circuit according to the present invention.

FIG. 6 is block diagram of circuit for compensating for changes in parameters in the delay circuit.

### DESCRIPTION OF THE PREFERRED EMBODIMENT

### 1. Detailed Description of the Figures

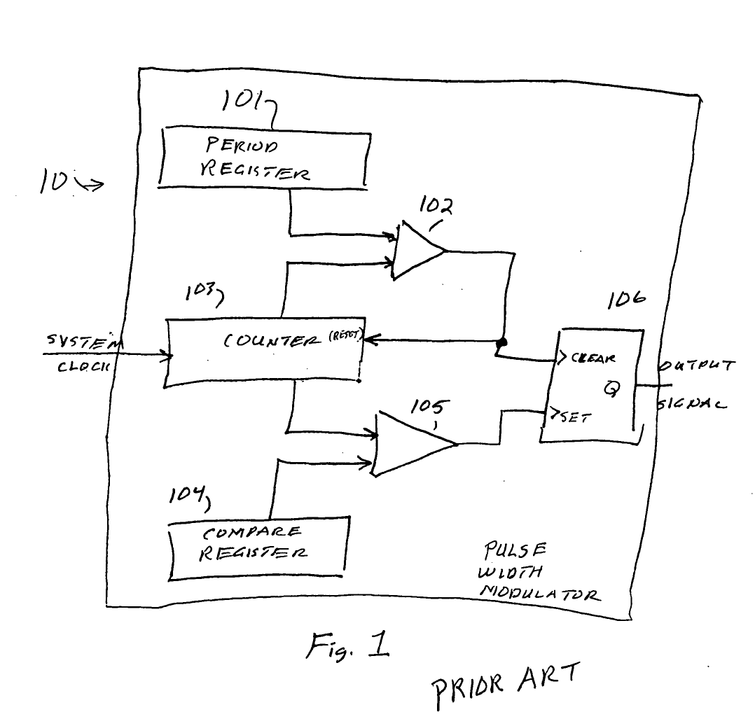

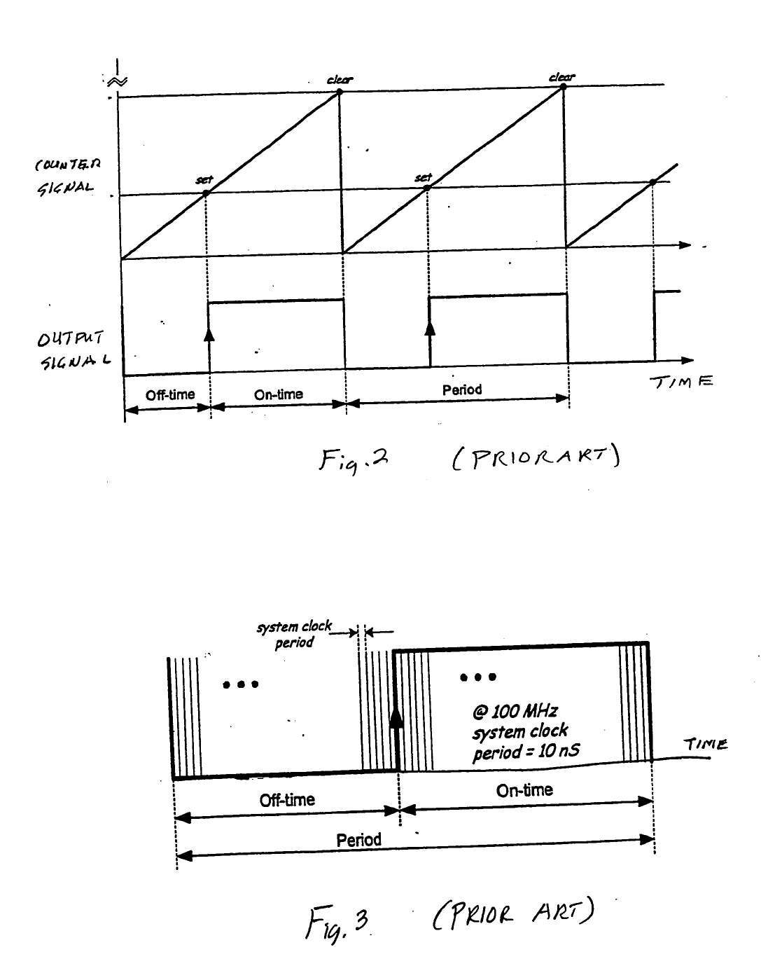

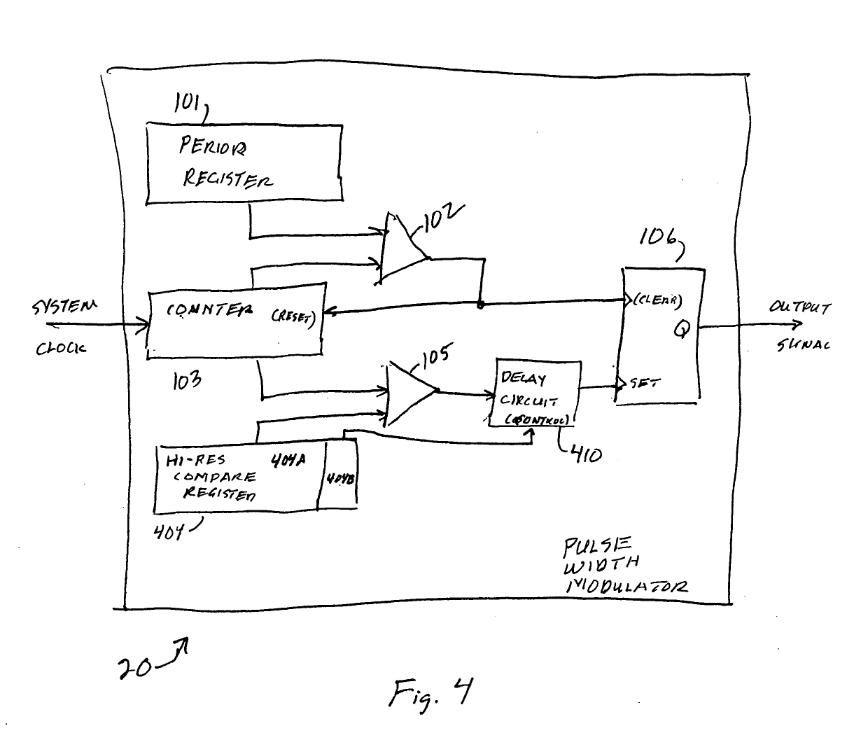

FIG. 1, FIG. 2, and FIG. 3 having been discussed with respect to the related art.

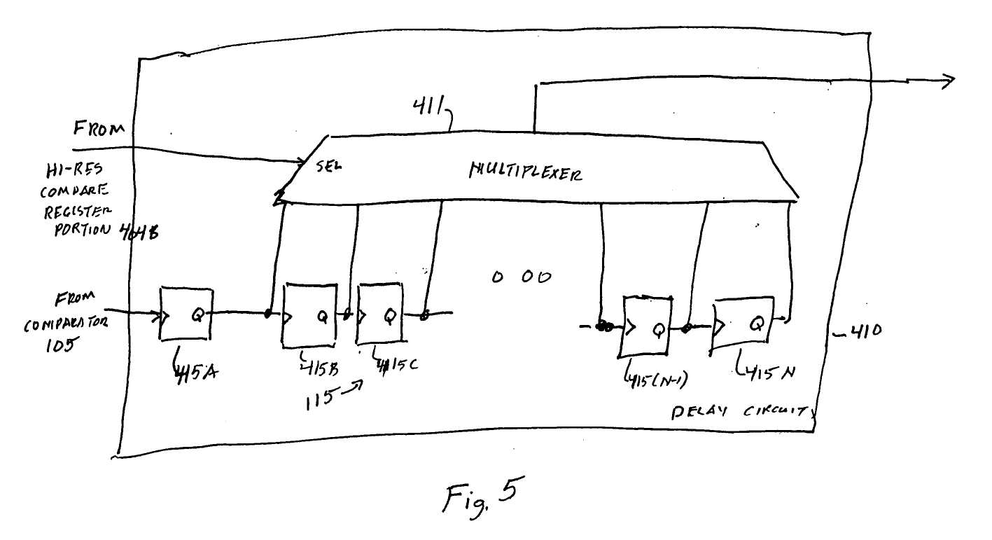

Referring to FIG. 4, a block diagram of a pulse width modulator 20, according to the present invention, is shown. Comparing FIG. 4 with FIG. 1, the counter 103, the period register 101, the comparators 102 and 105, and the DQ flip-flop 106 operate in a manner similar to the operation described with respect to FIG. 1. However, the compare register 104 is implemented as a hi-res compare register 404. The hi-res compare register 404 is divided into two parts, a register portion 404A analogous to the compare register 104, and register portion 404B. The output terminal of the comparator 105 is applied to an input terminal of delay circuit 410. The output terminal of delay circuit 410 is applied to the set terminal of Q flip-flop 106. The contents of hi-res register portion 404B are applied to a control (set) terminal of delay circuit 410.

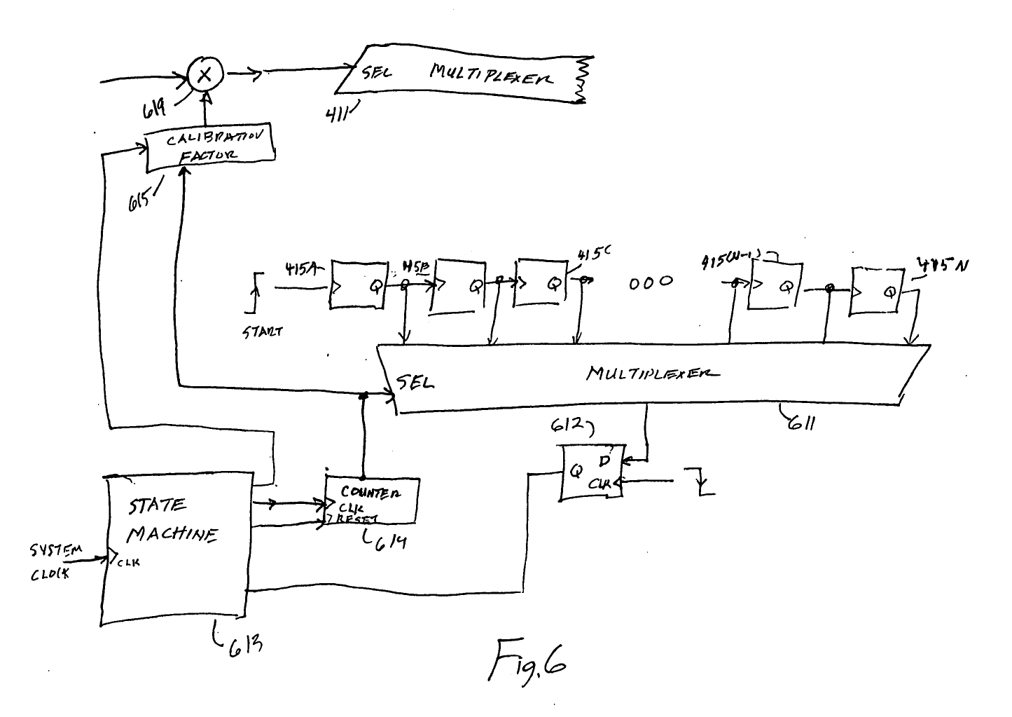

Referring to FIG. 5, a block diagram of the delay circuit 410, according to the present invention, is shown. The delay circuit 410 includes a multiplexer 411 and a plurality of delay elements 415A-415N, such as gates, coupled in series. The signal from the comparator 105 is applied to an input terminal of a delay line 115 implemented by the delay elements 415A-415N, The input terminals of the multiplexer 410 are coupled to the terminal connecting the output terminal of a delay element to the input terminal of the next sequential delay element. The signals from hi-res register portion 404B are applied to the control terminal of the multiplexer 411. As will be clear, the number of delay elements and the characteristics thereof are chosen so that total delay of the series of delay elements is greater than a clock cycle by a factor determined by min/max process variation. The pulse generated by the comparator 105 when the count in counter 103 is equal to the contents of the register portion 404A is applied to the series of delay elements 415A-415N. The pulse propagates along the series of delay elements 415A through 415N. The signals from register portion 404B determine the point in the delay line at which the applied pulse is applied to the output terminal of the multiplexer 411 and consequently to the set terminal of DQ flip-flop 106. The selection of the multiplexer input terminal provides the additional fraction of the clock cycle used to generate the signal ending the pulse width modulator delay.

As is well known, the parameters of a delay line are sensitive to temperature, process variation, and other ambient factors. Referring to FIG. 6, a circuit for compensating for the changes in parameters of the delay circuit 410 is shown. In addition to the components shown in FIG. 5, the compensation includes a multiplexer 611 having an input terminal coupled to connections between the delay elements 415A-415N. The output terminal of multiplexer 611 is coupled to a D terminal of a DQ flip-flop 612. The clk terminal of DQ flip-flop 616 receives the trailing edge of the system clock signal. The Q terminal of the DQ flip-flop 612 provides a status signal to the state machine 613. The state machine 613 receives a system clock signal, applies a control signal to calibration factor register 615, and applies a clock signal and a reset signal to counter 614. The counter 614 applies a control signal to the multiplexer 614 and to calibration factor register 615. The delay line 415 provides the signal resulting in the signal being applied to the DQ flip-flop 106. An output signal from the calibration unit is applied to a multiplier/scaling circuit 619.

### 2. Operation of the Preferred Embodiment

The operation of the present invention can be understood as follows. A pulse width modulator typically is controlled by counting of clock pulses. After a first number of clock pulses, the pulse width modulator generates the leading edge of a rectangular waveform and, at the time of a second number of pulses, the trailing edge of the rectangular is generated. Because of the problems of generating and transmitting high frequency signals, a limit is imposed on the frequency of the system clock. Even at the highest available system clock frequencies, the ability to control precisely the duty cycle of the pulse width modulator signals may not be satisfactory for modern integrated circuit applications. To increase the effective granularity of the clock signal without increasing the system clock frequency and thereby improve the sensitivity of the pulse width modulator signal duty cycle, the pulse controlling the generation of the trailing edge of the pulse width modulator signal is applied to a delay line with a plurality of delay elements. The signal between each pair of delay of coupled delay elements can be selected and applied to the circuit actually generating the leading edge of the pulse width modulator signal. Because the delay resulting from the delay elements is smaller than the system clock cycle, a number of incremental time delays can be imposed between the end of the clock cycle that would normally generate the leading edge of the pulse width modulator signal and the actual time at which trailing edge is generated. In this manner, the granularity of the leading edge can be increased.

Because delay elements can vary during the operation of a circuit, a calibration unit can be used to compensate for these variations. In essence, the calibration circuit determines the number of delay elements that are required to cause the output pulse from the delay line to be delayed by one clock cycle. When this number of elements is known, then the number of elements needed for a signal to propagate across the delay elements for a predetermined period of time can be determined. The counter applies a signal to the calibration multiplexer that insures the number of delay elements is sufficient to provide the maximum delay envisioned by the duty cycle of the pulse width modulator. The value of the counter is also applied to the calibration factor register to provide a signal to a multiplier/scaling unit. The multiplier/scaling unit insures the variability in the delay elements is compensated for when generating the control signal for determining the leading edge of the pulse width modulator signal.

While the invention has been described with respect to the embodiments set forth above, the invention is not necessarily limited to these embodiments. Accordingly, other embodiments, variations, and improvements not described herein are not necessarily excluded from the scope of the invention, the scope of the invention being defined by the following claims.

1. A pulse width modulator comprising:
a first comparison unit, the first comparison unit generating a first pulse after a first predetermined number of clock cycles;
a second comparator unit, the second comparison unit generating a second pulse after a second number of clock cycles, the second predetermined number being less than the first predetermined number;
a delay element having the second pulse applied thereto; and
a signal generating unit, the signal generating unit applying a signal to an output terminal in response to application of the second signal from the delay line, the signal generating unit removing the output signal from the output terminal in response to the first pulse.

2. The pulse width modulator as recited in claim 1 wherein the first and second pulses are generated after the first comparison unit and the second comparison units are reset.

3. The pulse width modulator as recited in claim 1 wherein the second pulse determines the duty cycle of the pulse width modulator signal.

4. The pulse width modulator as recited in claim 1 wherein the delay element includes:
a plurality of delay elements, the second pulse signal being applied to the first delay element; and
a selection element, the selection element selecting the out signal from selected one of the delay elements.

5. The pulse width modulator as recited in claim 4 further comprising a compensation circuit, the compensation circuit compensating for changes in the parameters of the delay elements.

6. The pulse width modulator as recited in claim 5 wherein the compensation circuit includes:
a clock period circuit coupled to the delay element, the clock period circuit determining the number of delay elements delaying a signal for one clock period; and
a calibration factor circuit coupled to the clock period circuit, the calibration circuit correcting the number of delay elements through which the second pulse is propagated for changes in delay element parameters.

7. A method for providing a pulse width modulator signal having an adjustable duty cycle, the method comprising:
determining period for the pulse width modulator signal using a predetermined number of clock cycles;
providing course determination of pulse width modulator signal duty cycle using a preselected number of clock cycles; and
providing a corrected determination of the pulse width modulator signal duty cycle using a selected number of delay elements.

8. The method as recited in claim 7 further comprising correcting for parameter changes in the delay elements.

9. The method as recited in claim 7 further comprising generating a first signal after the predetermined number of clock cycles.

10. The method as recited in claim 7 further comprising generating a second pulse after the preselected number of cycles.

11. The method as recited in claim 10 wherein delay elements are coupled in series, The method further comprising applying the second pulse to the series of delay elements.

12. A pulse width modulator circuit having a selectable duty cycle, the circuit comprising:
a first signal generating circuit generating a reset pulse after a predetermined number of clock cycles after a reset pulse;
a second signal generating circuit generating a first pulse a preselected number of clock cycles after the reset pulse;
a series of delay elements coupled in series, the first pulse be applied thereto;
a selection circuit, the selection circuit providing a selected first pulse after the first pulse had traveled through a selected number of delay elements; and
a signal generating unit, the signal generating unit providing an output signal in response to the selected first pulse, the signal generating unit output signal being reset to zero in response to the reset signal.

13. The circuit as recited in claim 12 further comprising a correction circuit, the correction circuit correcting for a change in the parameters of the delay elements by changing the number of delay elements in the path of the first pulse.

14. The circuit as recited in claim 12 wherein the correction circuit includes apparatus for determining the number of delay line time delays in a signal clock cycle.
